(19) United States
(12) Patent Application Publication
(10) Pub. No.: US 2024/0405575 A1
(43) Pub. Date: Dec. 5, 2024

(54) FAST CHARGING SYSTEM, ONE TO MANY FAST CHARGING DATA CABLE, AND CHARGING MANAGEMENT DEVICE

(71) Applicant: SHENZHEN BAITENGDA TRADING CO., LTD, Shenzhen (CN)

(72) Inventor: Baotong Chen, Shenzhen (CN)

(21) Appl. No.: 18/797,997

(22) Filed: Aug. 8, 2024

Related U.S. Application Data
(63) Continuation of application No. PCT/CN2022/108787, filed on Jul. 29, 2022.

(51) Int. Cl. H02J 7/00

(52) U.S. Cl. CPC H02J 7/00047; H02J 7/00032; H02J 7/0047

(57) ABSTRACT

A fast charging system, a one to many fast charging data cable, and a charging management device. The charging data cable comprises a charging input terminal, a plurality of charging output terminals and a charging management device, wherein the charging management device is used for controlling, when a device to be charged is connected at at least one charging output terminal, the turning-on of a data communication channel corresponding to the charging output terminal, which is connected to the device to be charged, so as to acquire rated charging information of the device to be charged; for converting, according to the rated charging information, a power source signal received by the charging input terminal into a power source output signal which matches the rated charging information; and for charging, by means of the power source output signal, the device to be charged, which is connected to the charging output terminal.

### CROSS REFERENCE TO RELATED APPLICATIONS

The present application is a Continuation Application of PCT Application No. PCT/CN2022/108787 filed on Jul. 29, 2022, the contents of which are incorporated herein by reference in their entirety.

### TECHNICAL FIELD

The present disclosure relates to the field of charging cables, and particularly relates to a fast charging system, a one to many fast charging data cable, and a charging management device and a method thereof.

### BACKGROUND ART

Since the fast charging technology is widely used in various mobile devices, charging time periods of the devices have been significantly shortened. However, the traditional one-to-two or one-to-three data cables usually take a USB A male header as input terminals, and take two or three of Micro USB, Lightning USB, or TYPE-C as output terminals. Therefore, these cables can only be used in scenarios where a USB A female receptacle is available. With the convenience and compact size, a TYPE-C terminal has become increasingly popular among users. Although a data cable that takes the TYPE-C terminal as the input end has been invented, it fails to be capable of providing fast charging and normal charging when two output interfaces are provided, and additionally, the cable is inconvenient for charging the devices at high power, such as laptop computers, and mobile phones.

In summary, there is a demand for multi-port data cables capable of quickly charging multiple devices simultaneously.

### SUMMARY OF THE INVENTION

The present disclosure aims to solve the main technical problem that how to provide a fast charging system capable of supporting fast charging of a plurality of consumption device, a one to many fast charging data cable, and a charging management device.

According to a first aspect, an embodiment provides a charging input interface, including a first data transmission pin;
a plurality of charging output interfaces, where each of the charging output interfaces includes a second data transmission pin; the second data transmission pin of each of the charging output interfaces can be connected to the first data transmission pin of the charging input interface to form a conductive data communication path, such that communication between the charging input interface and the corresponding charging output interface is implemented; and
a power management module configured to detect whether each of the charging output interfaces is connected to a consumption device; and when the power management module detects that at least one charging output interface is connected to one consumption device, one data communication path corresponding to the charging output interface connected to the consumption device is controlled to be powered on to obtain rated charging information of the consumption device, such that the charging output interface connected to the corresponding consumption device outputs a power output signal matching the rated charging information.

According to a second aspect, an embodiment provides a charging management device, including one charging input interface, a plurality of the charging output interfaces, and the power management module;
where the charging management device has a standby mode, a single charging mode, and a multiple charging mode;
when the power management module detects that none of the charging output interfaces is connected to the consumption device, the power management module controls the charging management device to enter the standby mode, in which mode, the power management module controls the second data transmission pin of each of the charging output interfaces to be disconnected from the first data transmission pin of the charging input interface;
when the power management module detects that only one charging output interface is connected to a consumption device, the power management module enters the single charging mode, in which mode, the power management module controls the data communication path corresponding to the one charging output interface to be powered on to obtain rated charging information of the consumption device, such that the one charging output interface connected to the corresponding consumption device outputs a power output signal matching the rated charging information; and
when the power management module detects that at least two charging output interfaces are connected to consumption device, the power management module enters the multiple charging mode, in which mode, the power management module controls the data communication path corresponding to the at least two charging output interfaces to be powered on to obtain rated charging information of the consumption device, such that the at least two charging output interfaces connected to the corresponding consumption device output power output signals matching the rated charging information of the corresponding consumption device.

According to a third aspect, an embodiment provides a one to many fast charging data cable, including:
a charging input terminal;
a plurality of charging output terminals;
the charging management device according to the foregoing embodiment is configured to control the corresponding data communication path to be powered on to obtain rated charging information of a consumption device when at least one charging output interface is connected to the consumption device, such that the corresponding charging output interface outputs a power output signal matching the rated charging information; and
the charging input terminal is connected to a charging input interface, and the charging output terminals are connected to the corresponding charging output interfaces.

According to a fourth aspect, an embodiment provides a fast charging system, including:
a charging dock, including a power output;
the consumption device, including a power input; and
the one to many fast charging data cable as described in the foregoing embodiment, the charging input terminal of the one to many fast charging data cable is connected to the power output of the charging dock, and the charging output terminal of the one to many fast charging data cable is connected to the power input of the consumption device.

According to a fifth aspect, an embodiment provides a charging management method, which is applied to the charging management device described in the foregoing embodiment, where the charging management method includes:
detecting whether each of the charging output interfaces is connected to a consumption device; and
when it is detected that at least one charging output interface is connected to a consumption device, the corresponding data communication path is controlled to be powered on to obtain rated charging information of the consumption device, such that the charging output interface connected to the corresponding consumption device outputs a power output signal matching the rated charging information.

The one to many fast charging data cable according to the foregoing embodiment includes a charging input interface, the plurality of charging output interfaces and the charging management device, where the charging management device is configured to control the corresponding data communication path to be powered on to obtain rated charging information of a consumption device when at least one charging output interface is connected to the consumption device, convert the power signal received by the charging input interface into a power output signal matching the rated charging information according to the rated charging information, and charge the consumption device connected to the charging output interface through the power output signal; therefore, the one to many fast charging data cable provided by the present disclosure can simultaneously fast charge a plurality of consumption device connected thereto.

### DESCRIPTION OF THE DRAWINGS

FIG. 1 is a structural schematic diagram of a fast charging system according to an embodiment of the present disclosure.

FIG. 2 is a structural schematic diagram of a one to many fast charging data cable according to an embodiment of the present disclosure.

FIG. 3 is a structural schematic diagram of a charging management device according to an embodiment of the present disclosure.

FIG. 4 is a structural schematic diagram of a power management module according to an embodiment of the present disclosure.

FIG. 5 is a structural schematic diagram of a power management module according to another embodiment of the present disclosure.

FIG. 6 is a structural schematic diagram of a power management module according to one more embodiment of the present disclosure.

FIG. 7 is a schematic circuit diagram of a voltage stabilizing unit according to an embodiment of the present disclosure.

FIG. 8 is a schematic circuit diagram of a main control unit according to an embodiment of the present disclosure.

FIG. 9 is a schematic circuit diagram of a step-down unit according to an embodiment of the present disclosure.

FIG. 10 is a schematic diagram of a first power supply channel switch unit circuit according to an embodiment of the present disclosure.

FIG. 11 is a schematic diagram of a second power supply channel switch unit circuit according to an embodiment of the present disclosure.

FIG. 12 is a schematic circuit diagram of an input voltage acquisition unit according to an embodiment of the present disclosure.

FIG. 13 is a schematic circuit diagram of an access detection unit according to an embodiment of the present disclosure.

FIG. 14 is a schematic circuit diagram of a fast charging reminder unit according to an embodiment of the present disclosure.

FIG. 15 is a flow chart of a charging management method according to an embodiment of the present disclosure.

### DETAILED DESCRIPTION OF THE EMBODIMENTS

The present disclosure will be further described in detail below with reference to specific embodiments and accompanying drawings. Similar elements in different embodiments are labeled with associated similar element labels. In the following embodiments, more details are described to facilitate clearer understanding of the present disclosure. However, those skilled in the art can readily recognize that some of the features can be omitted in different cases, or can be replaced by other elements, materials, and methods. In some cases, some operations related to the present disclosure are not shown or described in the specification, with the aim of preventing the important part of the present disclosure from being overwhelmed by excessive description, and for those skilled in the art, it is unnecessary to describe these related operations in detail, and they can gain a thorough understanding of the related operations according to the description in the specification and the general technical knowledge in the field.

In addition, the features, operations, or characteristics described in the specification can be combined in any suitable manner to form various embodiments. Furthermore, the steps or actions stated in the methods can also be sequentially exchanged or adjusted in terms of sequence in a manner obvious to those skilled in the art. Therefore, various sequences in the specification and drawings are merely for clear description of an embodiment, and are not intended to be a necessary sequence, unless otherwise specified that a certain sequence must be followed.

The serial numbers assigned to the components herein, such as “first”, “second”, are only used to distinguish the described objects, and do not have any sequence or technical meaning. The terms “connection” and “coupling” mentioned herein include direct and indirect connection (coupling), unless otherwise specified.

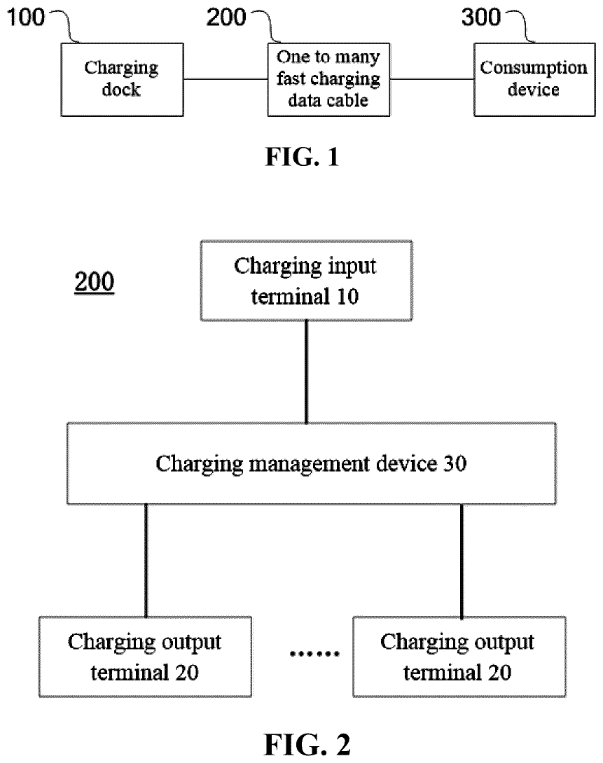

With reference to FIG. 1, a fast charging system according to an embodiment of the present disclosure includes: a charging dock 100, a consumption device 300, and a one to many fast charging data cable 200, where the one to many fast charging data cable 200 is connected between an output interface of the charging dock 100 and a charging interface of the consumption device 300. Specifically, the charging dock 100 is a charging dock 100 having a fast charging function, the charging dock 100 has a plurality of preset fast charging modes, different fast charging modes have different charging voltages, the charging dock is in communication connection with the consumption device 300 through the one to many fast charging data cable 200, and the consumption device 300 can send a handshake signal to the charging dock 100, such that the charging dock 100 can obtain the charging voltages required by the consumption device 300 through the handshake signal to switch to a corresponding fast charging mode; and under the control of the fast charging mode, a power signal capable of meeting the consumption device 300 for fast charging is outputted, the power signal is outputted to the consumption device 300 through a power supply path in the one to many fast charging data cable 200, such that the consumption device completes fast charging.

With reference to FIG. 2, the one to many fast charging data cable 200 according to an embodiment of the present disclosure includes: a charging input terminal 10, a plurality of charging output terminals 20 and a charging management device 30, where the charging input terminal 10 is connected to the charging dock having the fast charging function and is configured to receive the power signal outputted by the charging dock, the charging output terminal 20 is configured to be connected to the consumption device, the charging management device 30 is configured to control a corresponding data communication path when the consumption device is connected to the at least one charging output terminal 20, that is, a communication connection between the consumption device and the charging dock 100 is established to obtain rated charging information of the consumption device connected to the charging output terminal 20, such that the corresponding charging output terminal 20 outputs a corresponding power output signal, and the consumption device connected to the charging output terminal 20 is quickly charged through the power output signal.

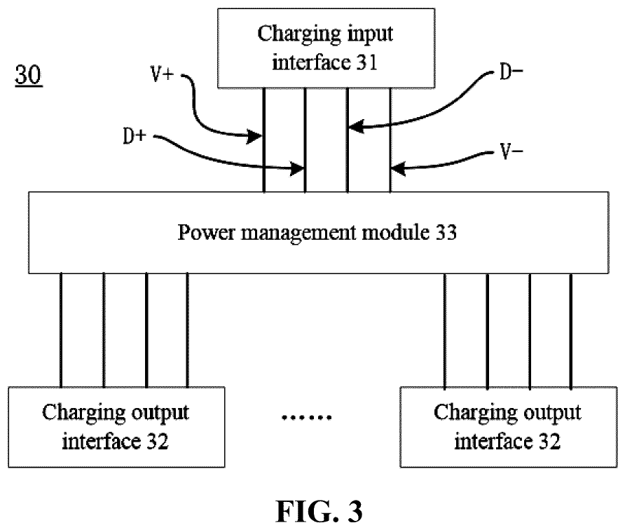

With reference to FIG. 3, FIG. 3 is a structural schematic diagram of the charging management device 30 according to an embodiment of the present disclosure, where the charging management device 30 includes a charging input interface 31, charging output interfaces 32, and a power management module 33, the charging input interface 31 is connected to the charging input terminal 10, the charging output interfaces 32 are connected to the charging output terminals 20 of the one to many fast charging data cable in a one-to-one correspondence, the charging input interface 31 includes a first data transmission pin and a first power transmission pin, the charging output interfaces 32 each includes a second data transmission pin and a second power transmission pin, the first data transmission pin can be connected to a plurality of the second data transmission pins respectively to form a plurality of the data communication paths (D+/D−), therefore, when the plurality of the data communication paths (D+/D−) are conducted, the charging input interface 31 can establish a communication protocol with the consumption device connected to the charging output interface 32 through the data communication path, such that the data communication path can be used to directly detect whether the consumption device connected to the charging output interface 32 needs to be fast charged and to obtain rated charging information, and the like; and the power management module 33 is connected to the plurality of the data communication paths, and when it is detected that the at least one charging output interface 32 is connected to the consumption device, the power management module 33 controls the data communication path corresponding to the charging output interface 32 connected to the consumption device to be powered on, so as to obtain rated charging information of the connected consumption device. Specifically, the data communication path is in an off state in a default state. In addition, the first power transmission pin can be connected to the plurality of the second power transmission pins to form a plurality of power supply paths (V+/V−); the power management module 33 is further connected to the plurality of power supply paths, and is configured to control the power supply path corresponding to the charging output interface 32 connected to the consumption device to be powered on when it is detected that the at least one charging output interface 32 is connected to the consumption device, and to output a power output signal matching the rated charging information to the charging output interface 32 connected to the corresponding consumption device according to the rated charging information of the consumption device.

It should be noted that the charging output interface 32, the second data transmission pins and the second power transmission pins are in one-to-one correspondence.

First, relevant structural units controlling the turning on/off of the plurality of the data communication paths by the power management module 33 are described below.

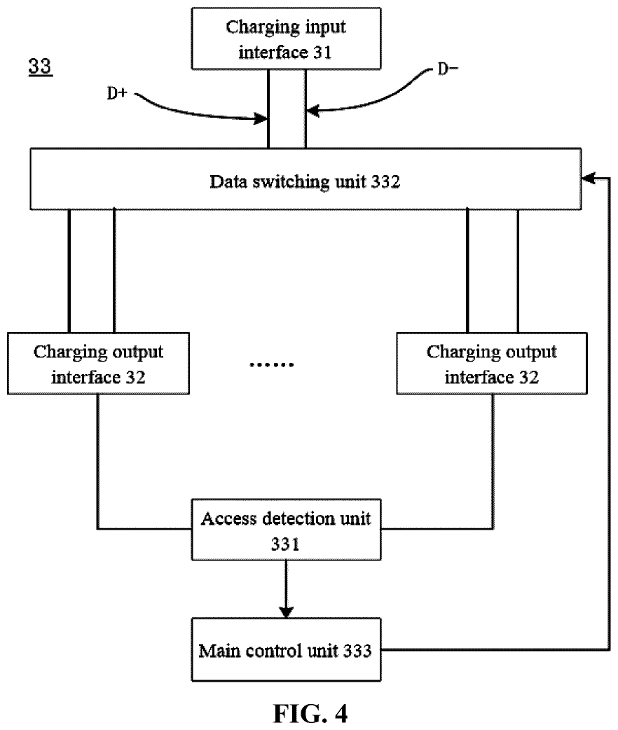

With reference to FIG. 4, in an embodiment, the power management module 33 includes an access detection unit 331, a data switching unit 332, and a main control unit 333.

The access detection unit 331 is respectively connected to the plurality of charging output interfaces 32 and is configured to detect whether each of the charging output interface 32 is connected to the consumption device, and to output corresponding connection information. When the charging output interface 32 is connected to the consumption device, valid connection information is outputted to the main control unit 333; and when the charging output interface 32 is not connected to the consumption device, invalid connection information is outputted to the main control unit 333.

The data switching unit 332 is connected between the first data transmission pin and the plurality of second data transmission pins, and is configured to have the corresponding data communication path powered on or off. In this embodiment, the data switching unit 332 controls the turning on/off of the data communication paths by receiving a control instruction outputted by the main control unit 333. In one embodiment, the data switching unit 332 can include only one data switching chip, which controls the plurality of data communication paths to be disconnected and conducted through one data switching chip, for example, one double-pole double-throw switch can be used for controlling two data communication paths; and in other embodiments, the data switching unit 332 can also include a plurality of the data switching chips, the plurality of the data switching chips correspond to the plurality of the data communication paths one by one, such that one data switching chip controls one corresponding data communication path to be powered on and off, for example, one single-pole single-throw switch is connected in each of the data communication paths for control.

The main control unit 333 is connected to the data switching unit 332 and the access detection unit 331 respectively, and is configured to control the data switching unit 332 to have the data communication path corresponding to the charging output interface 32 connected to the consumption device powered on/off in response to the connection information from the access detection unit 331, so as to obtain rated charging information of the consumption device connected to the charging output interface 32. In this embodiment, after decoding the connection information from the access detection unit 331, the main control unit 333 identifies whether each of the charging output interfaces 32 is connected to the consumption device, and then outputs a control instruction to the data switching unit 332 after detecting that the at least one charging output interface 32 is connected to the consumption device, the control instruction should include the at least identification information of the charging output interface 32, such that the data communication path corresponding to the charging output interface 32 connected to the consumption device can be controlled to be powered on through the data switching unit 332; and when it is detected that none of the charging output interfaces 32 is connected to the consumption device, the main control unit 333 is in a waiting state and does not output any control instruction to the data switching unit 332, and the data switching unit 332 is in an off state in a default state.

Second, relevant structural units controlling the turning on/off of the plurality of power supply paths by the power management module 33 are described below.

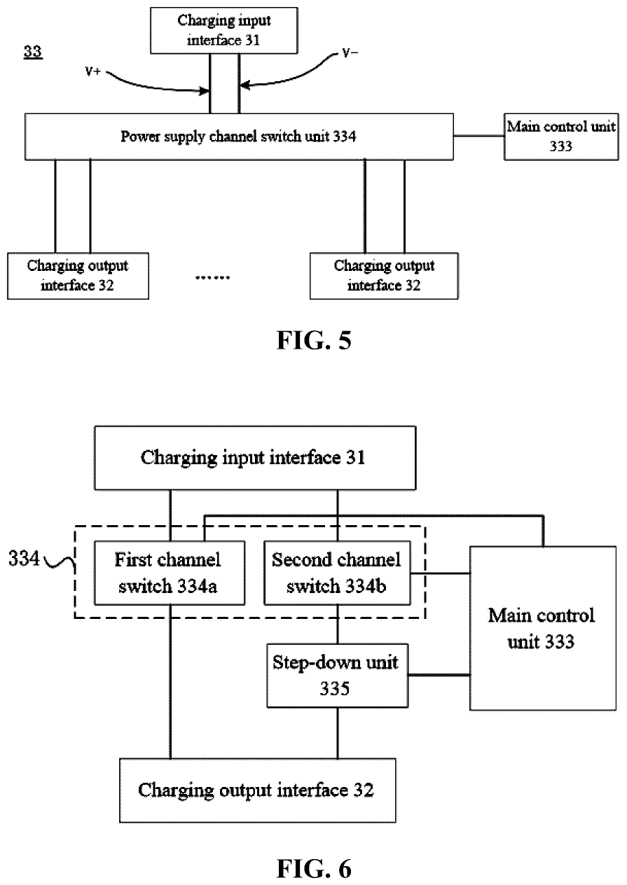

With reference to FIG. 5, in an embodiment, the power management module 33 further includes a power supply channel switch unit 334. The power supply channel switch unit 334 is connected between the first power transmission pin and a plurality of the second power transmission pins, and is configured to have the corresponding power supply path powered on or off.

The main control unit 333 is connected to the plurality of power supply channel switch units 334, and the main control unit 333 is configured to control the power supply channel switch unit 334 to have the power supply path corresponding to the charging output interface 32 connected to the consumption device powered on according to the connection information, and to output a power output signal matching the rated charging information to the charging output interface 32 according to the rated charging information of the consumption device. In this embodiment, after decoding the connection information from the access detection unit 331, the main control unit 333 identifies whether each of the charging output interfaces 32 is connected to the consumption device, and then outputs a control instruction to the power supply channel switch unit 334 after detecting that the at least one charging output interface 32 is connected to the consumption device, the control instruction should include the at least identification information of the charging output interface 32, such that the power supply channel switch unit 334 can control the power supply path corresponding to the charging output interface 32 connected to the consumption device to be powered on.

In one embodiment, when the at least two charging output interfaces 32 are connected to the consumption device, charging voltages of the different consumption device will be determined according to the rated charging information of the consumption device, and the charging voltages of the different consumption device can be the same or different, therefore, it is necessary to adjust a voltage of the power signal received by the charging input interface 31 to meet the fast charging requirements of different consumption device according to different situations.

Based on the foregoing requirements, with reference to FIG. 6, this embodiment introduces a step-down unit 335 based on the power management module shown in FIG. 5, where the step-down unit 335 is connected to the first power transmission pin and configured to step down a power signal outputted by the first power transmission pin. In addition, the power supply channel switch unit 334 includes a plurality of first channel switches 334a and a plurality of second channel switches 334b, the first channel switches 334a, the second channel switches 334b and the second power transmission pins are in one-to-one correspondence, the first channel switches 334a are connected between the first power transmission pin and the corresponding second power transmission pin, and the second channel switches 334b are connected between the step-down unit 335 and the corresponding second power transmission pins, that is, the first channel switches 334a are configured to control the first power transmission pin and the corresponding second power transmission pin to be turned and off, and the second channel switches 334b are configured to control whether the step-down unit 335 is connected between the first power transmission pins and the second power transmission pins.

For ease of description, this embodiment takes the charging output interface 32 corresponding to a maximum charging voltage of the consumption device as a main power output interface, and takes remaining charging output interfaces 32 connected to the consumption device as secondary power output interfaces according to the rated charging information of the consumption device connected to the at least two charging output interfaces 32 simultaneously. The main control unit 333 is configured to control the first channel switches 334a corresponding to the main power output interface to be powered on, and control the second channel switches 334b corresponding to the main power output interface to be powered off when it is detected that the at least two charging output interfaces 32 are connected to the consumption device simultaneously, that is, the consumption device connected to the main power output interface is fast charged directly through the power signal received by the charging input interface 31; and the second channel switches 334b corresponding to the secondary power output interfaces are controlled to be powered on, and the first channel switches 334a corresponding to the secondary power output interfaces are controlled to be powered off simultaneously, such that the second power transmission pins of the secondary power output interfaces are powered on through the power supply paths between the step-down unit 335 and the first power transmission pins, that is, the power signal received by the charging input interface 31 is stepped down and then outputted to fast charge the consumption device connected to the secondary power output interfaces.

For example, when at least two charging output interfaces 32 are connected to the consumption device simultaneously, charging voltages of the two consumption device are 9V and 20V respectively; and after detecting that the consumption device connected to the two charging output interfaces 32, the main control unit 333 controls the data switching unit 332 to turn on the data communication paths corresponding to the two charging output interfaces 32, such that the two to-be-charge devices establish a communication connection with the charging dock 100, the charging voltages of the two consumption device can be obtained according to a handshake signal, the charging dock 100 selects the corresponding charging mode according to the charging voltage of the consumption device with a higher charging voltage (20V), and outputs the power signal of the consumption device that meets the higher charging voltage (20V) to the charging input interface 31. According to the charging voltages of the two consumption device, the charging output interface 32 connected to the consumption device with the 20V charging voltage is taken as the main power output interface, the charging output interface 32 connected to the consumption device with the 9V charging voltage is taken as the secondary power output interface, and the main control unit 333 then controls the corresponding first channel switch 334a to turn on the power supply path between the second power transmission pin of the main power output interface and the first power transmission pin of the charging input interface 31, such that the power signal outputted by the charging dock 100 directly charges the 20V consumption device; and at the same time, the main control unit 333 controls the corresponding second channel switch 334b to turn on the second power transmission pin of the secondary power output interface and the step-down unit 335, such that the second power transmission pin of the secondary power output interface is powered on through the power supply path between the step-down unit 335 and the first power transmission pin, that is, that is, the power signal (20V) received by the charging input interface 31 is stepped down to the 9V power output signal, and finally, the power output signal (9V) is outputted to charge the 9V consumption device.

Therefore, when the at least two charging output interfaces 32 are simultaneously connected to the consumption device, after controlling the corresponding data communication path to be powered on, the charging management device 30 implements communication connection between the charging dock 100 and the consumption device, obtains the charging information of the consumption device connected to the charging output interface 32, and controls the corresponding power supply path to be powered on according to the charging voltages of the different consumption device to output a power output signal with a proper charging voltage to the corresponding charging output interface. The charging management device 30 provided in this embodiment of the present disclosure implements a function of fast charging a plurality of consumption device simultaneously.

In one embodiment, the charging management device 30 has a standby mode, a single charging mode, and a multiple charging mode; and the three modes are described below.

When the power management module 33 detects that none of the charging output interfaces 32 is connected to the consumption device, the power management module 33 controls the charging management device 30 to enter the standby mode, in which mode, the power management module controls the second data transmission pin of each of the charging output interfaces to be disconnected from the first data transmission pin of the charging input interface, and controls the second power transmission pin of each of the charging output interfaces to be disconnected from the first power transmission pin of the charging input interface.

When the power management module 33 detects that only one charging output interface 32 is connected to a consumption device, the power management module 33 controls the charging management device to enter the single charging mode, in which mode, the power management module 33 controls the data communication path corresponding to the charging output interface 32 connected to the consumption device to be powered on to obtain rated charging information of the consumption device, such that the one charging output interface 32 connected to the consumption device outputs a power output signal matching the rated charging information; in addition, the power management module 33 further controls a power supply path corresponding to the one charging output interface 32 connected to the consumption device to be powered on, and outputs a power output signal matching the rated charging information to the one charging output interface 32 connected to the corresponding consumption device according to the rated charging information of the consumption device.

When the power management module 33 detects that at least two charging output interface 32 is connected to the consumption device, the power management module 33 controls the charging management device to enter the multiple charging mode, in which mode, the power management module 33 controls the data communication path corresponding to the at least two charging output interfaces 32 connected to the consumption device to be powered on to obtain rated charging information of the consumption device, such that the at least two charging output interfaces 32 connected to the consumption device output the power output signal matching the rated charging information of the corresponding consumption device; and in addition, the power management module 33 further controls power supply paths corresponding to the at least two charging output interfaces 32 connected to the consumption device to be powered on, and outputs power output signals matching the rated charging information to the at least two charging output interfaces 32 connected to the corresponding consumption device according to the rated charging information of the consumption device, respectively.

In addition, the power management module 33 provided in this embodiment further includes a fast charging reminder unit, the fast charging reminder unit includes a plurality of groups of indicator lights corresponding to the plurality of charging output interfaces 32, respectively, the fast charging reminder unit is connected to the main control unit 333 and is configured to control an ON-OFF state of the indicator light corresponding to each of the charging output interfaces 32 according to a detection result of the main control unit 333 that whether the plurality of charging output interfaces 32 are connected to the consumption device. In one embodiment, the ON-OFF state of the indicator light includes ON, OFF, and/or FLASHING, for example, when the indicator light is ON, it indicates that the charging output interface 32 corresponding to the indicator light is being quickly charged; when the indicator light is OFF, it indicates that the charging output interface 32 corresponding to the indicator light is not charged; or when the indicator light is FLASHING, it indicates that the charging output interface 32 corresponding to the indicator light is charging slowly.

The power management module 33 provided in this embodiment further includes an input voltage acquisition unit and a voltage stabilizing unit, where the input voltage acquisition unit is configured to be connected to the main control unit 333, and the input voltage acquisition unit includes a detection resistor connected to the charging input interface 31; and the main control unit 333 acquires an input voltage value of the charging input interface according to the voltage value on the detection resistor, such that the main control unit 333 can obtain a voltage output by the charging input interface 31 in real time to avoid abnormal output voltage of the charging input interface 31. The voltage stabilizing unit converts the voltage outputted by the charging input interface 31 into a working voltage required by each circuit unit of the power management module 33 to supply power to each circuit unit.

It should be noted that specific implementation of the power management module 33 has been described in detail in the foregoing embodiments, and will not be further described herein.

Specific implementation circuit of the charging management device will be described below, and this embodiment is described by taking two charging output interfaces 32 as an example.

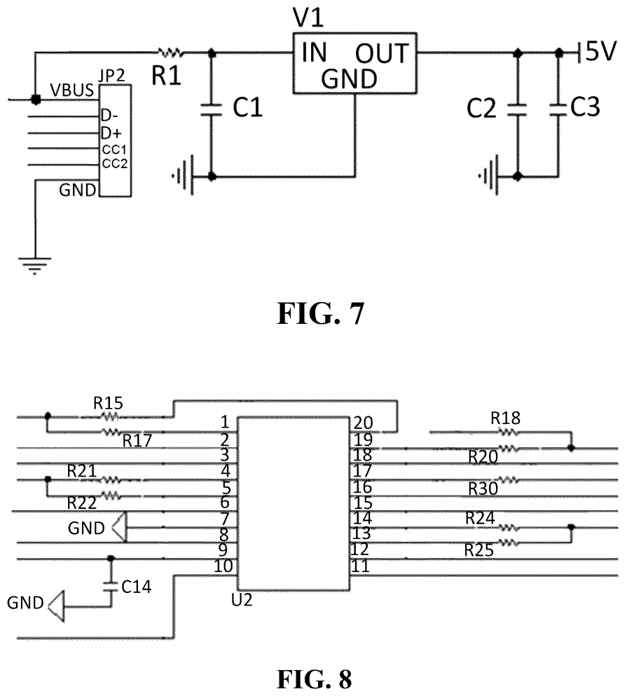

With reference to FIGS. 7-14, in one embodiment, the two charging output interfaces 32 are a TYPE-C output terminal JP1 and a TYPE-C output terminal JP3 respectively, the charging input interface 31 is a TYPE-C input terminal JP2, and the TYPE-C output terminal JP1 and the TYPE-C output terminal JP3 have a structure same as that of the TYPE-C input terminal JP2; and this embodiment takes the TYPE-C output terminal JP1 as an example for description, the TYPE-C output terminal JP1 includes a VBUS pin, a D+ pin, a D− pin, a CC1 pin, a CC2 pin and a GND pin, where the VBUS pin constitutes the second power transmission pin, and D+ pin and the D− pin constitute the second data transmission pins.

As shown in FIG. 7, the voltage stabilizing unit adopts a voltage stabilizing chip V1, with a model of eS8533, the voltage stabilizing chip V1 is configured to provide a 5V working voltage, an IN pin of the voltage stabilizing chip V1 is connected to the VBUS pin of the TYPE-C input terminal JP2 through a resistor R1, an OUT pin of the voltage stabilizing chip V1 is further connected to a ground through a capacitor C2 and a capacitor C3 connected in parallel, the GND pin of the voltage stabilizing chip V1 is connected to the ground, and the GND pin is further connected to the IN pin of the voltage stabilizing chip V1 through the capacitor C1.

As shown in FIG. 8, the main control unit 333 adopts a main control chip U2, with a model of CH376T; the data switching unit 332 adopts a switch chip IC1, with a model of BL1532; an SEL pin and an OEB pin of the switch chip IC1 are connected to a 2^{nd} pin and a 10^{th} pin of the main control chip U2, respectively; a DP1 pin and a DN1 pin of the switch chip IC1 are connected to the D+ pin and the D− pin of the TYPE-C output terminal JP1, and a DP2 pin and a DN2 pin are connected to the VBUS pin of the TYPE-C output terminal JP3. In this embodiment, a CC1 pin of the TYPE-C output terminal JP1 is connected to a 1^{st} pin of the main control chip U2 through a resistor R17, and is further connected to a 20^{th} pin of U2 through a resistor R15; the CC1 pin of the TYPE-C output terminal JP3 is connected to a 4^{th} pin of the main control chip U2 through a resistor R21, and is further connected to a 5^{th} pin of U2 through a resistor R22; the CC2 pin of the TYPE-C input terminal JP2 is connected to a 14^{th} pin of the main control chip U2 through a resistor R24, and is further connected to a 13^{th} pin of U2 through a resistor R25; and the CC1 pin of the TYPE-C input terminal JP2 is connected to a 17^{th} pin of the main control chip U2 through a resistor R30. In addition, a 7^{th} pin of the main control chip U2 is connected to the ground; a 9^{th} pin of the main control chip U2 is configured to receive a 5V working voltage outputted by a voltage stabilizing chip V1, and is further connected to the ground through a capacitor C14; and a 19^{th} pin of the main control chip U2 is sequentially connected to a resistor R20 and a resistor R18.

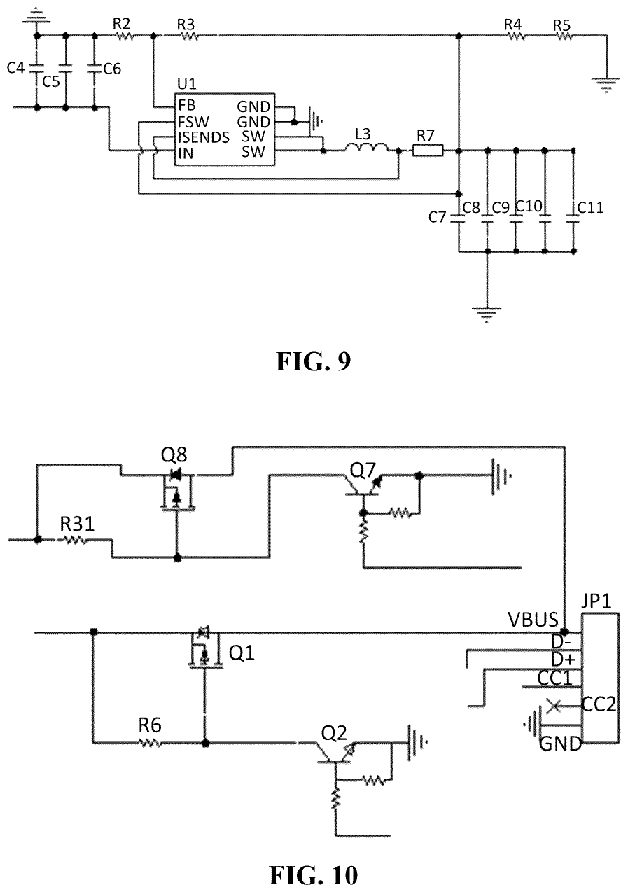

As shown in FIG. 9, the step-down unit 335 adopts a DC-DC step-down chip U1, with a model of CX8855, an IN pin of the step-down chip U1 is connected to the VBUS pin of the TYPE-C input terminal JP2, the IN pin of the step-down chip U1 is further connected to the ground through a capacitor C4, a point where the capacitor C4 intersects the ground is connected to a FB pin of the step-down chip U1 through a resistor R2, a capacitor C5 and a capacitor C6 are connected in parallel to both ends of the capacitor C4, two GND pins of the step-down chip U1 are connected to the ground, and a point where two SW pins thereof are connected is connected to one end of a capacitor C7 through an inductor L3 and a resistor R7, the other end of the capacitor C7 is connected to the ground, a capacitor C8, a capacitor C9, a capacitor C10 and a capacitor C11 are connected in parallel to both ends of the capacitor C7, a point where the resistor R7 intersects the capacitor C7 is connected to an FSW pin of the step-down chip U1, a point where the inductor L3 intersects the resistor R7 is connected to an ISENDS pin of the step-down chip U1, and a point where the resistor R7 intersects the capacitor C7 is further connected to the ground through a resistor R4 and a resistor R5.

The power supply channel switch unit includes two first channel switches 334a and two second channel switches 334b, where the two first channel switches 334a include a transistor Q1 and a transistor Q3, and the two second channel switches include a transistor Q4 and a transistor Q8, that is, the transistor Q1 and the transistor Q8 form a first power supply channel switch circuit, and the transistor Q3 and the transistor Q4 form a second power supply channel switch circuit.

As shown in FIG. 10, in the first power supply channel switch circuit, a first electrode of the transistor Q1 is connected to the VBUS pin of the TYPE-C input terminal JP2, the first electrode of the transistor Q1 is further connected to a control electrode of the transistor Q1 through a resistor R6, and a second electrode of the transistor Q1 is connected to the VBUS pin of the TYPE-C output terminal JP1; a first electrode of the transistor Q8 is connected to a SW pin of the step-down chip U1, the first electrode of the transistor Q8 is further connected to a control electrode of the transistor Q8 through a resistor R31, and a second electrode of the transistor Q8 is connected to the VBUS pin of the TYPE-C output terminal JP1; the control electrode of the transistor Q1 is connected to a first electrode of a transistor Q2, a second electrode of the transistor Q2 is connected to the ground, and a control electrode of the transistor Q2 is connected to a 12^{th} pin of the main control chip U2; and the control electrode of the transistor Q8 is connected to a first electrode of a transistor Q7, a second electrode of the transistor Q7 is connected to the ground, and a control electrode of the transistor Q7 is connected to a 15^{th} pin of the main control chip U2.

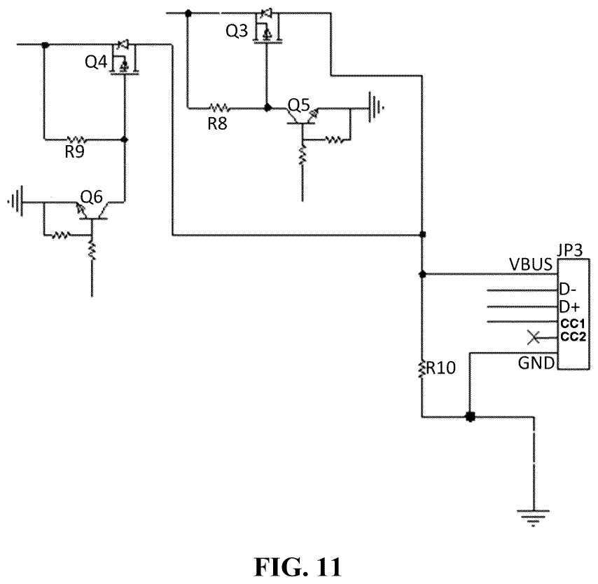

As shown in FIG. 11, in the second power supply channel switch circuit, a first electrode of the transistor Q3 is connected to the VBUS pin of the TYPE-C input terminal JP2, the first electrode of the transistor Q3 is further connected to a control electrode of the transistor Q3 through a resistor R8, and a second electrode of the transistor Q3 is connected to the VBUS pin of the TYPE-C output terminal JP3; a first electrode of the transistor Q4 is connected to the SW pin of the step-down chip U1, the first electrode of the transistor Q4 is further connected to a control electrode of the transistor Q4 through a resistor R9, and a second electrode of the transistor Q4 is connected to the VBUS pin of the TYPE-C output terminal JP3; the control electrode of the transistor Q3 is connected to a first electrode of a transistor Q5, a second electrode of the transistor Q5 is connected to the ground, and a control electrode of the transistor Q5 is connected to a 16^{th} pin of the main control chip U2; the control electrode of the transistor Q4 is connected to a first electrode of a transistor Q6, a second electrode of the transistor Q6 is connected to the ground, and a control electrode of the transistor Q6 is connected to a 11^{th} pin of the main control chip U2; and in addition, the VBUS pin of the TYPE-C output terminal JP3 is further connected to the group through a resistor R10.

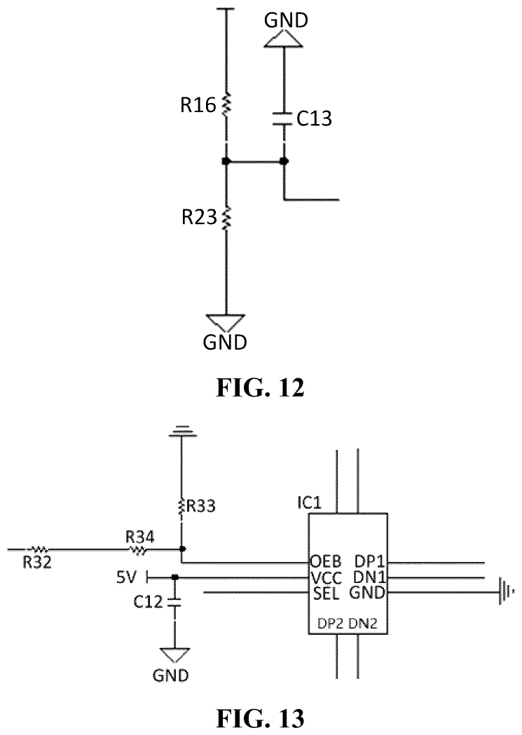

As shown in FIG. 12, the input voltage acquisition unit includes a resistor R16 and a resistor R23, one end of the resistor R16 is connected to the VBUS pin of the TYPE-C input terminal JP2, the other end of the resistor R16 is connected to one end of a 6^{th} pin of the main control chip U2 and one end of the resistor R23, and the other end of the resistor R23 is connected to the ground; and one end of the resistor R16 and the resistor R23 are connected to one end of the capacitor C13, and the other end of the capacitor C13 is connected to the ground.

As shown in FIG. 13, the access detection unit 331 adopts a switch chip IC1, with a model of BL1532, an SEL pin and an OEB pin thereof are respectively connected to a 2nd pin and a 10^{th} pin of the main control chip U2, the D+ pin and the D− pin of the TYPE-C output terminal JP1 are respectively connected to a DP1 pin and a DN1 pin of the switch chip IC1, a D+ pin and a D− pin of the TYPE-C output terminal JP3 are respectively connected to a DP2 pin and a DN2 pin of the switch chip IC1; and in addition, the OEB pin of the switch chip IC1 is connected to one end of a resistor R33 and one end of a resistor R34, the other end of the resistor R33 is connected to the group, and the other end of the resistor R34 are connected to a resistor R32; and a VCC pin of the switch chip IC1 is configure to receive a 5V working voltage and is connected to the ground through a capacitor C12.

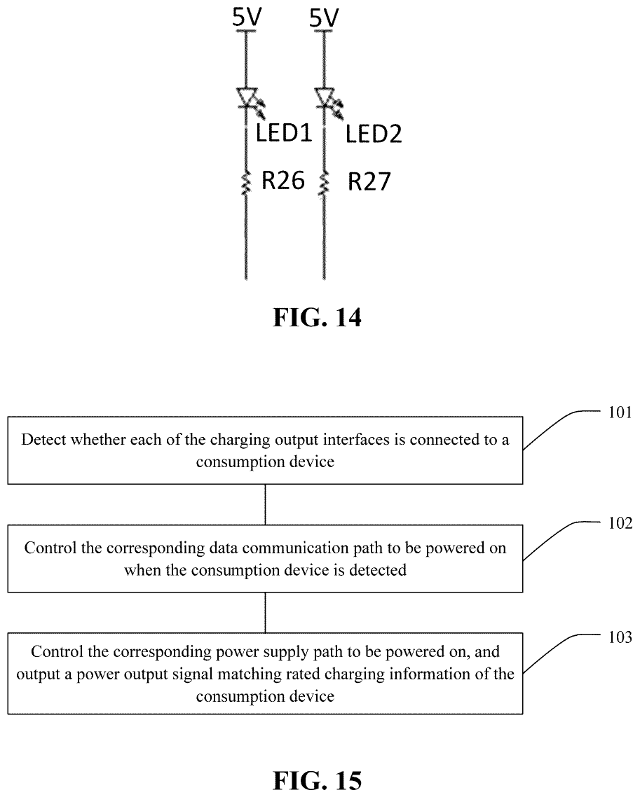

As shown in FIG. 14, the fast charging reminder unit includes a light emitting diode LED1 and a light emitting diode LED 2, an anode of the light emitting diode LED1 is configured to receive a 5V working voltage outputted by the voltage stabilizing chip V1, a cathode of the light emitting diode LED1 is connected to a 8^{th} pin of the main control chip U2 through a resistor R26, an anode of the light emitting diode LED 2 is configured to receive the 5V working voltage outputted by the voltage stabilizing chip V1, and a cathode of the light emitting diode LED2 is connected to a 18^{th} pin of the main control chip U2 through a resistor R27. In one embodiment, the LED1 is a red light emitting diode and is configured to indicate fast charging; and the LED 2 is a green light emitting diode and is configured to indicate slow charging.

Based on the charging management device 30 provided in the foregoing embodiments, with reference to FIG. 15, an embodiment of the present disclosure further provides a charging management method, which is applied to the main control unit and includes the following steps:
step 101: detect whether each of the charging output interfaces 32 is connected to a consumption device; when it is detected that none of the charging output interfaces 32 is connected to the consumption device, the charging management device a standby mode; and in the standby mode, each of the charging output interfaces 32 can be cyclically detected at intervals to identify whether it is connected to the consumption device, and the second data transmission pin of each of the charging output interfaces 32 is controlled to be disconnected from the first data transmission pin of the charging input interface 31;
step 102: when it is detected that at least one charging output interface 32 is connected to the consumption device, the data communication path corresponding to the charging output interface 32 connected to the consumption device is controlled to be powered on to obtain rated charging information of the consumption device; and
step 103: the corresponding power supply path is controlled to be powered on, a power output signal matching the rated charging information is outputted to the corresponding charging output interface according to the rated charging information of the consumption device.

In one embodiment, the step 102 further includes: when it is detected that only one charging output interface 32 is connected to a consumption device, the charging management device enters the single charging mode, in which mode, the data communication path corresponding to the one charging output interface 32 connected to the consumption device is controlled to be powered on to obtain rated charging information of the consumption device, such that the one charging output interface connected to the corresponding consumption device outputs a power output signal matching the rated charging information. The step 103 further includes: the power supply path corresponding to the one charging output interface connected to the consumption device is controlled to be powered on, and the power output signal matching the rated charging information is outputted to the corresponding charging output interface 32 according to the rated charging information of the consumption device.

In another embodiment, the step 102 further includes: when it is detected that at least two charging output interfaces 32 are connected to the consumption device, the charging management device the multiple charging mode, in which mode, the data communication paths corresponding to the at least two charging output interfaces 32 connected to the consumption device are controlled to be powered on to obtain rated charging information of the consumption device, such that the at least two charging output interfaces 32 connected to the corresponding consumption device output the power output signal matching the rated charging information of the corresponding consumption device. The step 103 further includes: the power supply paths corresponding to the at least two charging output interfaces 32 connected to the consumption device are controlled to be powered on, and the power output signal matching the rated charging information is outputted to the at least two corresponding charging output interfaces 32 according to the rated charging information of the at least two consumption device.

It should be noted that the specific implementations of the foregoing methods and steps are described in detail in the foregoing embodiments, and will not be further described herein.

The present disclosure is described above with specific examples, which are only used to facilitate understanding of the present disclosure, and are not intended to limit the present disclosure. Those skilled in the art to which the present disclosure belongs can make several simple deductions, variations or substitutions according to the ideas of the present disclosure.

1. A charging management device, comprising:
one charging input interface, comprising a first data transmission pin;
a plurality of charging output interfaces, wherein each of the charging output interfaces comprises a second data transmission pin; and the second data transmission pin of each of the charging output interfaces can be connected to the first data transmission pin of the charging input interface to form a conductive data communication path, such that communication between the charging input interface and the corresponding charging output interfaces is implemented; and
a power management module configured to detect whether each of the charging output interfaces is connected to a consumption device; and when the power management module detects that at least one charging output interface is connected to one consumption device, one data communication path corresponding to the charging output interface connected to the consumption device is controlled to be powered on to obtain rated charging information of the consumption device, such that the charging output interface connected to the corresponding consumption device outputs a power output signal matching the rated charging information;
wherein the charging input interface further comprises a first power transmission pin; each of the charging output interfaces further comprises a second power transmission pin; and the second power transmission pin of each of the charging output interfaces can be connected to the first power transmission pin of the charging input interface to form a conductive power supply path; and
the power management module is further configured to control the data communication path corresponding to the at least one charging output interface to be powered on to obtain rated charging information of the consumption device when only one charging output interface is connected to the consumption device, and outputs a power output signal matching the rated charging information to the corresponding charging output interface according to the rated charging information of the consumption device;
wherein the power management module further comprises:
a step-down unit connected to the first power transmission pin and configured to step down a power signal outputted by the first power transmission pin;
a power supply channel switch unit which comprises a plurality of first channel switches and a plurality of second channel switches; the first channel switches are connected between the first power transmission pin and the corresponding second power transmission pin, and the second channel switches are connected between the step-down unit and the corresponding second power transmission pin; and the first channel switches, the second channel switches and the second power transmission pin are in one-to-one correspondence; and
a main control unit which is respectively connected to the step-down unit, the plurality of first channel switches and the plurality of second channel switches, and is configured to control the first channel switch corresponding to the charging output interface connected to a consumption device with a maximum charging voltage to be powered on and the second channel switch to be powered off when it is detected that at least two charging output interfaces are simultaneously connected to the consumption device; and the main control unit is also configured to control the second channel switches corresponding to the charging output interfaces connected to the remaining consumption device to be powered on and the first channel switches to be powered off.

2. The charging management device according to claim 1, wherein the power management module further comprises:
an access detection unit respectively connected to the plurality of charging output interfaces and configured to detect whether each of the charging output interfaces is connected to the consumption device, and to output corresponding connection information;
a data switching unit connected between the first data transmission pin and the plurality of second data transmission pins, and configured to have the corresponding data communication path powered on or off; and
the main control unit is connected to the data switching unit and the access detection unit respectively, and configured to control the data switching unit to have the data communication path corresponding to the charging output interface connected to the consumption device powered on/off in response to the connection information, so as to obtain the rated charging information of the consumption device.

3. The charging management device according to claim 2,
the main control unit is connected to the power supply channel switch unit, and configured to control the power supply channel switch unit to have the power supply path corresponding to the charging output interface connected to the consumption device powered on according to the connection information, and to output a power output signal matching the rated charging information to the charging output interface according to the rated charging information of the consumption device.

4. The charging management device according to claim 1, wherein a number of the charging output interfaces is two, that is, a first charging output interface and a second charging output interface; and the power supply channel switch unit comprises two first channel switches and two second channel switches.

5. The charging management device according to claim 4, wherein the two first channel switches comprise a transistor Q1 and a transistor Q3; and the two second channel switches comprise a transistor Q4 and a transistor Q8;
a first electrode of the transistor Q1 is connected to the first power transmission pin of the charging input interface, and a second electrode of the transistor Q1 is connected to the second power transmission pin of the first charging output interface; a first electrode of the transistor Q8 is connected to the step-down unit, and a second electrode of the transistor Q8 is connected to the second power transmission pin of the first charging output interface; and control electrodes of the transistor Q1 and the transistor Q8 are connected to the main control unit; and
a first electrode of the transistor Q3 is connected to the first power transmission pin of the charging input interface, and a second electrode of the transistor Q3 is connected to the second power transmission pin of the second charging output interface; a first electrode of the transistor Q4 is connected to the step-down unit, and a second electrode of the transistor Q4 is connected to the second power transmission pin of the second charging output interface; and control electrodes of the transistor Q3 and the transistor Q4 are connected to the main control unit.

6. The charging management device according to claim 5, wherein the power supply channel switch unit further comprises a transistor Q5, a transistor Q6, a transistor Q2 and a transistor Q7;
the transistor Q5 is connected between the control electrode of the transistor Q3 and the main control unit, and is configured to control a control command outputted by the main control unit to the control electrode of the transistor Q3;
the transistor Q6 is connected between the control electrode of the transistor Q4 and the main control unit, and is configured to control a control command outputted by the main control unit to the control electrode of the transistor Q4;
the transistor Q2 is connected between the control electrode of the transistor Q1 and the main control unit, and is configured to control a control command outputted by the main control unit to the control electrode of the transistor Q1; and
the transistor Q7 is connected between the control electrode of the transistor Q8 and the main control unit, and is configured to control a control command outputted by the main control unit to the control electrode of the transistor Q8.

7. The charging management device according to claim 2, wherein the power management module further comprises:
an input voltage acquisition unit connected to the main control unit, wherein the input voltage acquisition unit comprises a detection resistor connected to the charging input interface; and the main control unit acquires an input voltage value of the charging input interface according to a voltage value on the detection resistor.

8. The charging management device according to claim 2, wherein the power management module further comprises:
a fast charging reminder unit comprising a plurality of groups of indicator lights corresponding to the plurality of charging output interfaces, respectively, the fast charging reminder unit is connected to the main control unit and is configured to control an ON-OFF state of each of the indicator lights corresponding to each of the charging output interfaces according to a detection result of the main control unit that whether the plurality of charging output interfaces are connected to the consumption device.

9. The charging management device according to claim 8, wherein the ON-OFF state of the indicator lights comprises ON, OFF, and/or FLASHING.

10. The charging management device according to claim 1, wherein the power management module further comprises:
a voltage stabilizing unit configured to provide a required working voltage for each unit of the power management module.

11. The charging management device according to claim 1, wherein when the data communication path is powered on, the power management module can transmit data with the corresponding consumption device and a charging dock through the data communication path.

12. The charging management device according to claim 1, wherein
the charging management device has a standby mode, a single charging mode, and a multiple charging mode;
when the power management module detects that none of the charging output interfaces is connected to a consumption device, the power management module controls the charging management device to enter the standby mode, in which mode, the power management module controls the second data transmission pin of each of the charging output interfaces to be disconnected from the first data transmission pin of the charging input interface;
when the power management module detects that only one charging output interface is connected to a consumption device, the power management module enters the single charging mode, in which mode, the power management module controls the data communication path corresponding to the one charging output interface to be powered on to obtain rated charging information of the consumption device, such that the one charging output interface connected to the corresponding consumption device outputs a power output signal matching the rated charging information; and
when the power management module detects that at least two charging output interfaces are connected to consumption device, the power management module enters the multiple charging mode, in which mode, the power management module controls the data communication path corresponding to the at least two charging output interfaces to be powered on to obtain rated charging information of the consumption device, such that the at least two charging output interfaces connected to the corresponding consumption device output power output signals matching the rated charging information of the corresponding consumption device.

13. The charging management device according to claim 12, wherein in the standby mode, the power management module controls the second power transmission pin of each of the charging output interfaces to be disconnected from the first power transmission pin of the charging input interface;
in the single charging mode, the power management module controls the data communication path corresponding to the one charging output interface to be powered on to obtain rated charging information of the consumption device, and outputs a power output signal matching the rated charging information to the corresponding charging output interface according to the rated charging information of the consumption device; and
in the multiple charging mode, the power management module controls the data communication paths corresponding to the at least two charging output interfaces to be powered on to obtain rated charging information of the consumption device, and outputs power output signals matching the rated charging information to the at least two corresponding charging output interfaces according to the rated charging information of the at least two consumption device.

14. A one to many fast charging data cable, comprising:
a charging input terminal;
a plurality of charging output terminals;
the charging management device according to claim 1, which is configured to control the corresponding data communication path to be powered on to obtain rated charging information of a consumption device when at least one charging output interface is connected to the consumption device, such that the corresponding charging output interface outputs a power output signal matching the rated charging information; and
the charging input terminal is connected to the charging input interface, and the charging output terminals are connected to the corresponding charging output interfaces.

15. The one to many fast charging data cable according to claim 14, wherein the charging output terminals each comprises at least two of an Apple interface, an Android interface, a micro interface, and a TYPE-C terminal.

16. The one to many fast charging data cable according to claim 14, wherein the charging input terminal comprises the TYPE-C terminal.

17. A fast charging system, comprising:
a charging dock, comprising a power output;
the consumption device, comprising a power input; and
the one to many fast charging data cable according to claim 14, wherein the charging input terminal of the one to many fast charging data cable is connected to the power output of the charging dock, and the charging output terminal of the one to many fast charging data cable is connected to the power input of the consumption device.
